(19) United States
(12) Patent Application Publication
(10) Pub. No.: US 2005/0044122 A1
(43) Pub. Date: Feb. 24, 2005

(54) System and method for predicting the interaction between proteins based on domain combination

(75) Inventors: Dong-Soo Han, Daejeon (KR); Hong-Soog Kim, Daejeon (KR); Jung-Min Seo, Daejeon (KR); Woo-Hyuk Jang, Daegu (KR)

Correspondence Address: BACON & THOMAS, PLLC, 625 SLATERS LANE, FOURTH FLOOR, ALEXANDRIA, VA, 22314, US

(73) Assignee: Information And Communications University Educational Foundation, Seoul (KR)

(21) Appl. No.: 10/771,407

(22) Filed: Feb. 5, 2004

(30) Foreign Application Priority Data
Aug. 18, 2003 (KR) 2003-56947

(51) Int. Cl. G06F 17/15

(52) U.S. Cl. 708/422

(57) ABSTRACT

Disclosed are a system and a method for statistically predicting an interaction probability between proteins, and more particularly to a system and a method for predicting an interaction probability between an unknown protein pair based on information obtained by analyzing differences between interacting and non-interacting sets of protein pairs from the view point of domain combination. The prediction method includes the steps of (a) obtaining appearance frequency information of a designated domain combination selected from each of interacting and non-interacting sets of protein pairs, and storing the obtained appearance frequency information, (b) determining a probability equation applied to predict the interaction between two proteins using the stored appearance frequency information of the domain combination, and (c) obtaining an interaction probability value between the two proteins from the determined probability equation.

### BACKGROUND OF THE INVENTION

1. Field of the Invention

The present invention relates to a system and a method for predicting the interaction between proteins, and more particularly to a system and a method for predicting the interaction probability between proteins based on domain combination pairs.

2. Description of the Related Art

Almost all reactions, such as signal transduction, cell life cycle, differentiation, DNA replication, transcription and translation, metabolism, etc., occurring in cells are achieved and controlled by the interactions of many proteins. Accordingly, research into biochemical development and mechanism in cells based on the interaction between proteins are main objects of modem biochemistry and molecular biology.

Conventionally, there are several approaches to the prediction of interactions between proteins without experimentation. For example, one approach is to find and analyze subsequences affecting the protein-protein interactions from raw protein subsequence. Another approach is to predict protein interactions by analyzing the physicochemical properties or tertiary structures of proteins.

Domain based protein-protein interaction prediction is yet another approach, and recently it is being actively studied by some research groups. Since domain does not represent all the details of the protein-protein interaction, the domain based protein-protein interaction prediction was not developed vigorously. Further, since data stored in the domain are not sufficient yet, the domain based protein-protein interaction prediction has reduced reliability in accuracy of the prediction. As the recent development of a communication network such as Internet causes the accumulation of a large quantity of protein data, efficiency in detecting structures and functions of proteins based on the protein data is improved.

However, previous domain based research usually only considered the interactions of single domain pairs. They have even assumed that the interactions of single domain pairs are independent of one another for computational convenience. This assumption might be the major reason for the limitations of conventional domain based prediction methods because protein-protein interaction could be affected by the interactions of multiple domain pairs or the interaction of groups of domains. As a result, the precision of the conventional domain based predictions is not high enough to allow effectively use in research or industrial fields. In order to overcome this limitation, we introduce the notion of domain combination and domain combinations pairs. The term domain combination is used to represent the set of domains.

### SUMMARY OF THE INVENTION

Therefore, the present invention has been made in view of the above problems, and it is an object of the present invention to provide a system and a method for predicting the interaction between proteins based on a plurality of domain pairs and domain combinations.

It is a further object of the present invention to provide a system and a method for predicting the interaction between proteins, in which appearance frequencies of domain combination pairs in an interacting set of protein pairs are computed and registered in a distribution.

It is another object of the present invention to provide a system and a method for predicting the interaction between proteins, in which the interaction between proteins is expressed by a distribution in a prediction model.

It is another object of the present invention to provide a system and a method for predicting the interaction between proteins, which analyzes the presence of other domains affecting the interaction between proteins, thus achieving more precise prediction.

It is another object of the present invention to provide a system and a method for predicting the interaction between proteins, which presents a probability value of the interaction, thus providing more realistic information compared to a conventional approach, which presents a simple score value based on a scoring system.

It is another object of the present invention to provide a system and a method for predicting the interaction between proteins using reduced expenses and in a short time.

It is yet another object of the present invention to provide a system and a method for predicting the interaction between proteins, which additionally uses information of random protein pairs supposed not to interact with each other, thus increasing the accuracy of the prediction.

In accordance with one aspect of the present invention, the above and other objects can be accomplished by the provision of a method for predicting the interaction between proteins, comprising the steps of: (a) obtaining appearance frequency information of a designated domain combination selected from each of interacting and non-interacting sets of protein pairs, and storing the obtained appearance frequency information; (b) determining a probability equation applied to predict the interaction between two proteins using the stored appearance frequency information of the domain combination; and (c) obtaining an interaction probability value between the two proteins from the determined probability equation.

Preferably, the step (a) may include the sub-steps of: (a-1) creating a weighted appearance frequency; and (a-2) creating an appearance probability (AP) matrix based on the weighted appearance frequency.

Further, preferably, the appearance frequency information of the domain combination may be defined by an appearance probability (AP) matrix, and an element APᵢⱼ of the AP matrix may be determined by below Equations,

$$\begin{matrix}{AP}_{ij} = \frac{{WF}_{ij}}{{\sum }_{i , j}^{} {WF}_{ij}} \\ WFab = {\sum }_{For all protein pairs pi , qj \\ s . t . 〈 a , b 〉 ∈ d c \text{-} pair ( pi , qj )}^{} \frac{1}{\vert d c ( {p}_{i} ) \vert \times \vert d c ( {q}_{j} ) \vert}\end{matrix}$$

Moreover, the step (c) may include the sub-steps of: (c-1) obtaining probability values and distributions of the probability values by applying the determined probability equation to the interacting and non-interacting sets of protein pairs; (c-2) obtaining a probability value by applying the determined probability equation to the given protein pair; and (c-3) computing a probability for determining which set the given protein pair belongs to based on the distributions of the interacting and non-interacting sets of protein pairs.

In accordance with another aspect of the present invention, there is provided a system for predicting the interaction between proteins comprising: a probability data storing unit for obtaining appearance frequency information of a designated domain combination selected from each of interacting and non-interacting sets of protein pairs and storing the obtained appearance frequency information; a probability equation determining unit for determining a probability equation applied to predict the interaction between two proteins, randomly selected, using the stored appearance frequency information of domain combination; and a probability equation computing unit for computing an interaction probability between the two proteins using the determined probability equation.

Preferably, the probability equation computing unit may obtain probability values and distributions of the probability values by applying the determined probability equation to the interacting and non-interacting sets of protein pairs, obtain a probability value by applying the determined probability equation to the given protein pair, and then compute a probability for determining which set the protein pair belongs to based on the distributions of the interacting and non-interacting sets of protein pairs.

In accordance with yet another aspect of the present invention, there is provided a computer readable recording media for recording a program for achieving the method for predicting the interaction between proteins by means of a computer.

### BRIEF DESCRIPTION OF THE DRAWINGS

The above and other objects, features and other advantages of the present invention will be more clearly understood from the following detailed description taken in conjunction with the accompanying drawings, in which:

FIG. 1 is a schematic view of a conventional model for predicting the interaction between proteins based on domain pairs;

FIG. 2 is a schematic view of one example of domain combination pairs in accordance with the present invention;

FIG. 3 is a flow chart illustrating a method for predicting the interaction between proteins in accordance with the present invention;

FIG. 4 is a schematic view illustrating domain combination categories to which each element belongs, when domain combination is made, in accordance with the present invention;

FIG. 5 is a graph illustrating PIP distributions of interacting and non-interacting sets of protein pairs;

FIG. 6 is a schematic view illustrating a system for predicting the interaction between proteins in accordance with the present invention; and

FIG. 7 is a block diagram of a general purpose computer employed by a method for predicting the interaction between proteins in accordance with the present invention.

### DESCRIPTION OF THE PREFERRED EMBODIMENTS

Now, preferred embodiments of the present invention, i.e., a system and a method for predicting the interaction between proteins base on domain combination, will be described in detail with reference to the annexed drawings.

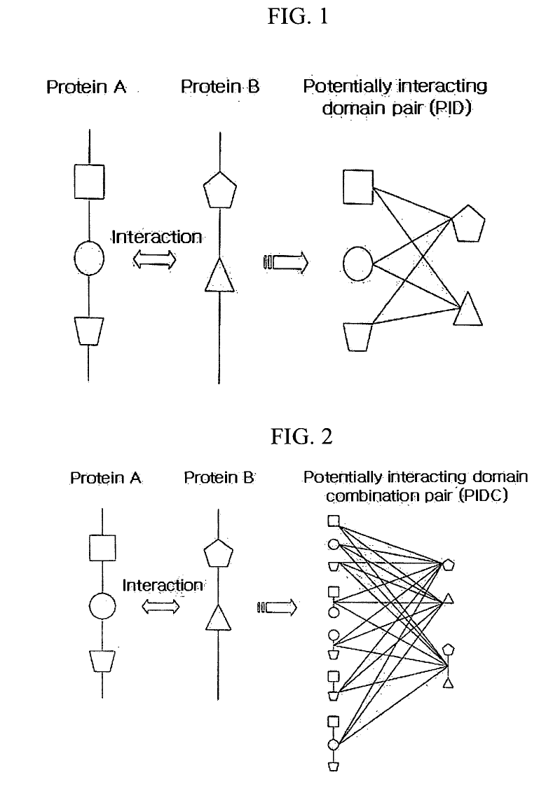

FIG. 1 is a schematic view of a conventional approach to predict the interaction between proteins based on domain pairs. As shown in FIG. 1, the conventional approach is based on the assumption that the protein-protein interactions depend on single domain pairs. FIG. 1 illustrates potentially interacting domain (PID) pair when two proteins with 3 and 2 single domains interact with each other.

Prior to the description of a prediction model proposed by the present invention, the notion of domain combination and domain combination pair will be described. Hereinafter, for convenience of the description, the domain combination and the domain combination pair are respectively denoted by dc and dc-pair in short form.

In case that a protein p contains multiple domains, then the domain combination of protein p is all possible groups of domains that can be formed from the set of domains of protein p. Here, the groups must contain at least one domain. That is, the set of all possible domain combinations of protein p is defined by Equation 1, as follows.
dc(p)=PowerSet(domain(p))−{Ø} [Equation 1]

Here, domain(p) represents the set of domains in protein p. As shown in Equation 1, the domain combination is obtained by eliminating the empty set (Ø) from the power set P(A) of the set of domains. Thus, when the protein p contains n domains, 2ⁿ−1 different domain combinations are obtained.

In such a prediction model proposed by the present invention, the domain combination is considered as a basic element of protein interactions, and it is assumed that one or more domain combinations in the same protein can be involved in invoking protein interactions. That is, when two proteins interact with each other, their interaction is interpreted as the result of the interaction of the mutual domain combinations. In order to represent this relation, a notation of domain combination pairs formed by two proteins is introduced. The set of all the possible domain combination pairs of two proteins p and q is defined by Equation 2, as follows.
dc-pair(p,q)={<dc1,dc2>|<dc1,dc2>εdc(p)×dc(q)ordc(q)×dc(p)} [Equation 2]

Thus, when two proteins p and q have n and m different domains respectively, (2ⁿ−1)×(2^{m}−1) different domains dc-pairs are obtained from the proteins.

FIG. 2 is a schematic view of one example of domain combination pairs in accordance with the present invention. FIG. 2 illustrates potentially interacting dc-pairs when two proteins with 3 and 2 domains interact with each other. FIG. 2 contrasts the domain combination pair based approach of the present invention with the conventional domain pair based approach as shown in FIG. 1. It is predicted that the accumulation of the interacting protein pairs on the Internet has made this approach feasible because the extraction of dc-pairs from quite a number of interacting protein pairs helps to identify and strengthen core dc-pairs in invoking protein interactions. Further, the appropriate weight assignment to strengthen the role of dc-pairs is also important, and this will be described later.

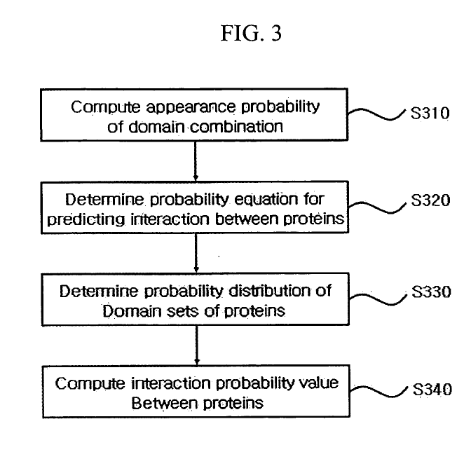

FIG. 3 is a flow chart illustrating a method for predicting the interaction between proteins in accordance with the present invention.

The method for predicting the interaction between proteins in accordance with the present invention comprises a prediction service preparation stage and a prediction stage.

The prediction service preparation stage includes three steps. In a first step (S310) of the prediction service preparation stage, domain combination and appearance frequency information of domain combination is obtained from sets of protein pairs known to interact with each other (hereinafter, referred to as “interacting sets of protein pairs”) and sets of protein pairs known not to interact with each other (hereinafter, referred to as “non-interacting sets of protein pairs”). The obtained information is stored in the form of an arrangement structure called an appearance probability (AP) matrix.

In a second step (S320) of the prediction service preparation stage, a probability equation to predict protein-protein interactions is defined based on the AP matrix. The defined probability equation contains an undefined constant and the value of the constant is determined by maximum likelihood estimation. Finally, in a third step (S330) of the prediction service preparation stage, the PIP (Primary Interaction Probability) distributions of interacting and non-interacting sets of protein pairs are obtained.

In the prediction stage, another probability equation for predicting the protein-protein interactions based on the distributions obtained in the third step of the prediction service preparation stage is defined, and a probability is calculated by using the probability equation. The obtained probability serves as a final probability for predicting the protein-protein interactions.

Hereinafter, the details of each step will be described with reference to FIG. 3.

First, in step (S310), the appearance frequency of domain combinations is calculated. In this step, the appearance frequency of domain combinations required to define the probability equation for predicting the interaction between proteins is extracted from the interacting set of proteins and the non-interacting set of proteins. In order to collect data regarding the appearance frequency of domain combinations, more particularly the frequency of a designated domain combination in a set of protein pairs, the AP matrix is constructed.

When there are n different proteins {p1, p2, . . . , pn} in a given set of protein pairs and the union of domain combinations of proteins contains m different domain combinations, {dc₁, dc₂, . . . , dcₘ}, i.e., the union of dc(p1), dc(p2), . . . , dc(pn) is computed to {dc₁, dc₂, . . . , dcₘ}, and then an m×m AP matrix constructed. The element Apᵢⱼ in the matrix represents the appearance probability of domain combination <dcₐdc_{b}> in the given set of protein pairs.

For the construction of the AP matrix, a weighted frequency (WF) matrix is first constructed. Here, each row and column represents a domain combination and each element of the matrix represents a dc-pair. In the WF matrix, the appearance frequencies of domain combinations in a given set of protein pairs are registered. The element WFab in the matrix holds a weighted appearance frequency of domain combination <a, b> in the given set of protein pairs and its value is computed by Equation 3, as follows.

$$WFab = {\sum }_{For all protein pairs pi , qj \\ s . t . 〈 a , b 〉 ∈ d c \text{-} pair ( pi , qj )}^{} \frac{1}{\vert d c ( {p}_{i} ) \vert \times \vert d c ( {q}_{j} ) \vert} \qquad [ Equation 3 ]$$

That is, the final result of Equation 3 is computed by adding up the expression 1/(|dc(pᵢ)|)×(|dc(qⱼ)|) for all the protein pairs <pᵢ, qⱼ> which contain dc-pair <a, b>.

Now, Equation 3 is used to compute the elements of the WF matrix. In case that Equation 3 is applied to an example containing proteins A, B and C with domains including domain(A)={a₁, a₂}, domain(B)={b₁}, and domain(C)={a₁, c₁}, and a set of interaction protein pairs {<A, B>, <A, C>, <B, C>} is given. In order to construct the WF matrix or the proteins A, B, and C, the matrix elements for all possible dc-pairs of the given set of protein pairs should be computed. The expression 1/(|dc(B)|)×(|dc(A)|) is used to compute the element WF{b₁}{a₁} because the domain combination <{b₁}{a₂}> appears only in dc-pair(A, B). As dc(A)={{a₁}, {a₂}, {a₁, a₂}}, dc(B)={{b₁}}, (|dc(A)|)=3, and (↑dc(B)|)=1, the expression 1/(|dc(B)|)×(|dc(A)|) yields a value of ⅓. The other elements of the WF matrix are computed in a similar manner. Once the WF matrix is constructed, AP matrix construction is rather straightforward. Each element of the AP matrix is computed by Equation 4, as follows.

$${AP}_{ij} = \frac{{WF}_{ij}}{{\sum }_{i , j}^{} {WF}_{ij}} \qquad [ Equation 4 ]$$

That is, the AP matrix is obtained by dividing the WF of a designated element by the total values of the WFs of all elements.

Then, each element of the AP matrix represents its appearance probability in the whole dc-pair space. Since there are sample spaces on each set of interacting and non-interacting protein pairs, two AP matrixes are generated. Large portions of the two matrices may be shared or overlap each other, but they need not to be coincident in the shape or the components of the matrices.

Since the appearance probabilities of the set of interacting protein pairs and the set of non-interconnecting protein pairs are respectively obtained, the obtained AP matrices are respectively denoted as APⁱ and AP^{r} and their intersection APⁱ ∩ Ap^{r} is denoted as AP^{c}. Their detailed definitions are given below.
Ap^{r}: AP matrix constructed from the set of non-interacting protein pairs
APⁱ: AP matrix constructed from the set of interacting protein pairs
AP^{c}: APⁱ ∩ Ap^{r}

Once the AP matrices for interacting and non-interacting sets of protein pairs are constructed, a dc-pair can be categorized by discerning which matrix it belongs to and the categories can be named using the APⁱ, AP^{r}, and AP^{c} notations. All the dc-pairs composing the APⁱ matrix constitute the APⁱ dc-pair space. In the same manner, AP^{r} dc-pair and AP^{c} dc-pair spaces are constituted.

Next, in the second step (S320), a probability equation to predict the probability for an interaction-unknown protein pair <A, B> to interact with each other based on the two AP matrices obtained in the first step, is defined, and an undefined constant in the probability equation is determined.

First, all the possible dc-pairs are computed from the protein pair <A,B> by means of Equation 2. Since many dc-pairs can be formed, and there are several categories in the dc-pair space, the dc-pairs are classified by the categories of the dc-pair space and denoted as follows:
DC_{c}(A,B)={dc-pair|dc-pair ∈ dc-pair (A,B) and appears in AP^{c} dc-pair space}
DC_{r-c}(A,B)={dc-pair|dc-pair ∈ dc-pair (A,B) and appears in {AP^{r}−AP^{c}} space}
DC_{i-c}(A,B)={dc-pair|dc-pair ∈ dc-pair (A,B) and appears in {APⁱ−AP^{c}} space}

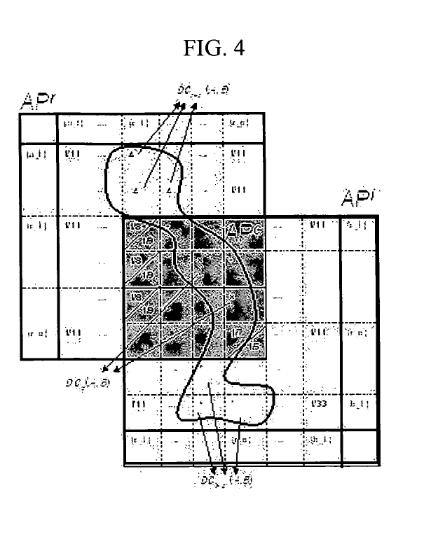

FIG. 4 shows which elements belong to which categories when dc-pair(A,B) is constructed on the spaces of APⁱ, AP^{r}. The elements of dc-pair(A,B) in FIG. 4 are denoted by special symbols (*, Δ, x).

Now, an interaction probability equation is defined by Equation 5 when DC_{c}(A,B) is detected in the AP^{c} dc-pair space.

The probability implies a probability for a protein pair<A,,B> to interact when DC_{c}(A,B) appears in the AP^{c} dc-pair space. A random variable X is introduced to denote the interacting and non-interacting events. In Equation 5, the value 1 represents an interacting event, and the value 0 represents a non-interacting event.

$$P ( X = 1 \vert D Cc ( A , B ) ) = \frac{P ( X = 1 ) P ( D Cc ( A , B ) \vert X = 1 )}{\begin{matrix}P ( X = 1 ) P ( D Cc ( A , B ) \vert X = 1 ) + \\ P ( X = 0 ) P ( D Cc ( A , B ) \vert X = 0 )\end{matrix}} \qquad [ Equation 5 ]$$

Here, P(X=1), P(X=0), P(DC_{c}(A,B)|X=1), and P(DC_{c}(A,B)|X=0) are defined, as follows.

$$\begin{matrix}P ( X = 1 ) = \frac{k \cdot {I}_{total} \cdot {\sum }_{i , j}^{} {( {AP}_{1}^{c} )}_{ij}}{k \cdot {I}_{total} \cdot {\sum }_{i , j}^{} {( {AP}_{I}^{c} )}_{ij} + ( 1 - k ) \cdot {R}_{total} \cdot {\sum }_{i , j}^{} {( {AP}_{R}^{c} )}_{ij}} \\ P ( X = 0 ) = \frac{( 1 - k ) \cdot {R}_{total} \cdot {\sum }_{i , j}^{} {( {AP}_{R}^{c} )}_{ij}}{k \cdot {I}_{total} \cdot {\sum }_{i , j}^{} {( {AP}_{I}^{c} )}_{ij} + ( 1 - k ) \cdot {R}_{total} \cdot {\sum }_{i , j}^{} {( {AP}_{R}^{c} )}_{ij}} \\ P ( D Cc ( A , B ) \vert X = 1 ) = \vert D Cc ( A , B ) \vert ! {\prod }_{\{ i , j \vert ( i , j ) ∈ DCc ( A , B ) \}}^{} \frac{{( {AP}_{I}^{c} )}_{ij}}{{\sum }_{i , j}^{} {( {AP}_{I}^{c} )}_{ij}} \\ P ( D Cc ( A , B ) \vert X = 0 ) = \vert D Cc ( A , B ) \vert ! {\prod }_{\{ i , j \vert ( i , j ) ∈ DCc ( A , B ) \}}^{} \frac{{( {AP}_{R}^{c} )}_{ij}}{{\sum }_{i , j}^{} {( {AP}_{R}^{c} )}_{ij}}\end{matrix}$$

Here, P(X=1) represents the ratio of the set of interacting dc-pairs to the total dc-pairs in AP^{c}, whereas P(X=0) represents the ratio of the set of non-interacting dc-pairs to the total dc-pairs in AP^{c}. Iₜₒₜₐₗ and Rₜₒₜₐₗ in the above equations represent the total number of interacting and non-interacting protein pairs, respectively. The constant k is inserted into the equation because the exact ratio of Iₜₒₜₐₗ and Rₜₒₜₐₗ in nature is not known, and the value of optimal k is estimated by maximum likelihood estimation.

P(DC_{c}(A,B)|X=1) denotes the probability that the set of dc-pairs DC_{c}(A,B) appears in APⁱ space, and P(DC_{c}(A,B)|X=0) denotes the probability that the set of dc-pairs DC_{c}(A,B) appears in AP^{r} space. AP₁^{c} and AP_{R}^{c} denote AP^{c} in interacting dc-pair space and non-interacting dc-pair space, respectively. Equivalently, the interaction probability equation when the domain combinations Dc_{i-c}(A,B) are detected in APⁱ-AP^{r} space, is defined by Equation 6, as follows.

$$\begin{matrix}P ( X = 1 \vert DCi - c ( A , B ) ) = & [ Equation 6 ] \\ \frac{P ( X = 1 ) P ( D {C}_{i - c} ( A , B ) \vert X = 1 )}{P ( X = 1 ) P ( D {C}_{i - c} ( A , B ) \vert X = 1 ) + P ( X = 0 ) P ( D {C}_{i - c} ( A , B ) \vert X = 0 )} & \\ P ( X = 1 \vert DCi - c ( A , B ) ) = & \\ \frac{P ( X = 1 ) P ( D {C}_{i - c} ( A , B ) \vert X = 1 )}{P ( X = 1 ) P ( D {C}_{i - c} ( A , B ) \vert X = 1 ) + P ( X = 0 ) P ( D {C}_{i - c} ( A , B ) \vert X = 0 )} & \end{matrix}$$

In Equation 6, P(X=1) is computed to 1 and P(X=0) is computed to 0. Thus, the final probability is computed to 1. Using Equations 5 and 6, PIP (Primary Interaction Probability) of a protein pair (A,B) with dc-pairs DC_{c}(A,B) is defined by Equation 7, as follows.

$$PIP ( A , B ) = 1 - \frac{{AP}^{c}}{{AP}^{i}} ( 1 - P ( X = 1 \vert DCc ( A , B ) ) \qquad [ Equation 7 ]$$

Once the final equation of PIP is obtained in the second step (S320), the PIP values can be computed by applying Equation 7 to the interacting and non-interacting sets of protein pairs (S330 and S340).

In accordance with another embodiment of the present invention, when all the PIP values of each set are computed, PIP distributions are obtained, and are then normalized to compare them. From this, a PIP function is interpreted to be a function which maps a protein pair to a real number in the range of 0 to 1.

Once the distributions are obtained, the interaction prediction of a protein pair is reduced to a two-category classification problem on the distributions. That is, in order to predict whether the two proteins in a given protein pair interact or not, it is determined which distribution the PIP value of the protein pair belongs to. The two-category classification includes many techniques. In order to represent the interaction probability of a protein pair, a conditional probability of the protein pair and then it is determined which category the protein pair belongs to.

For example, in order to predict the interaction probability of a protein pair <A,B>, DC(A,B) is first computed and then PIP(A,B) is then computed using Equation 7. Thereafter, the final interaction probability of the protein pair <A,B> is computed by Equation 8, as follows.

$$\begin{matrix}P ( X = 1 \vert p = PIP ( A , B ) ) = \\ \frac{P ( X = 1 ) P ( p = PIP ( A , B ) \vert X = 1 )}{P ( X = 1 ) P ( p = PIP ( A , B ) \vert X = 1 ) + P ( X = 0 ) P ( p = PIP ( A , B ) \vert X = 0 )}\end{matrix} \qquad [ Equation 8 ]$$

Here, P(X=1), P(X=0), P(p=PIP(A,B)|X=1), and P(p=PIP(A,B)|X=0) are defined, as follows.

$$\begin{matrix}P ( X = 1 ) = \frac{k \cdot {\sum }_{i = 1}^{m } {freq}_{i}^{x}}{k \cdot {\sum }_{i = 1}^{ m} {freq}_{i}^{x} + ( 1 - k ) {\sum }_{i = 1}^{m } {freq}_{i}^{y}} \\ P ( X = 0 ) = \frac{( 1 - k ) \cdot {\sum }_{i = 1}^{m } {freq}_{i}^{y}}{k \cdot {\sum }_{i = 1}^{m } {freq}_{i}^{x} + ( 1 - k ) {\sum }_{i = 1}^{m } {freq}_{i}^{y}} \\ P ( p = PIP ( A , B ) \vert X = 1 ) = \frac{{freq}_{PIP ( A , B )}^{x}}{{\sum }_{i = 1}^{m } {freq}_{i}^{x}} \\ P ( p = PIP ( A , B ) \vert X = 0 ) = \frac{{freq}_{PIP ( A , B )}^{y}}{{\sum }_{i = 1}^{n } {freq}_{i}^{y}}\end{matrix}$$

Here, P(X=1) represents the ratio of interacting sets of protein pairs to the total sets of protein pairs, whereas P(X=0) represents the ratio of non-interacting sets of protein pairs to the total sets of protein pairs. Further, freqᵢ^{x} represents a frequency of a sample having PIPᵢ^{x}, that appears in the interacting sets of protein pairs, and freqᵢ^{y} represents a frequency of a sample having PIPᵢ^{y}, that appears in the no n-interacting sets of protein pairs. The constant k is the same as that used in Equation 5.

P(p=PIP(A,B)|X=1) denotes the probability that the stochastic variable p in the interacting set is PIP(A,B). Equivalently, P(p=PIP(A,B)|X=0) denotes the probability that the stochastic variable p in the non-interacting set is PIP(A,B). According to circumstances, a sample having PIP(A,B) may be nonexistent in the sets. In this case, the probability equation variable p is replaced by a value, which is in a predetermined range.

Next, the validation of the prediction method proposed by the present invention will be described. For the validation, two sets of protein pairs were prepared. The interacting set of protein pairs ((Yeast)20030202.1^{st}) were acquired from DIP data base (http://dip.doembi.ucla.edu), where 15,174 interacting protein pairs in Yeast organism were prepared for the validation. On the other hand, as there was no data on the non-interacting set of protein pairs, the non-interacting set of protein pairs was artificially generated by randomly paring the reported proteins with domain information in Yeast organism. The domain information of all the proteins was detected from PAD(http://www.ebi.ac.uk/proteome/) (with reference to R. Apweiler, M. Biswas, W. Fleischmann, A. Kanapin, Y. Karavidopoulou, P. Kersey, E. V. Kriventseva, V. Mittard, N. Mulder, I. Phan and E. Zdobnov, Proteome Analysis Database: online application of Interpro and CluSTr for the functional classification of proteins in whole genomes. Nucleic Acids Res., 29(1):44-48, 2001) (4932. SPC). When preparing the non-interacting set of protein pairs, all the protein pairs that appeared in the interacting set of protein pairs were eliminated and for the convenience of the validation, the same number (15,174) of non-interacting protein pairs were prepared. Although it could be guaranteed that all the interacting protein pairs were excluded in the artificially generated non-interacting set of protein pairs, if the conjecture that the interacting protein pairs are sparse in the whole protein pair space holds, the obtained non-interacting set of protein pairs would be sufficient to be used in our prediction model.

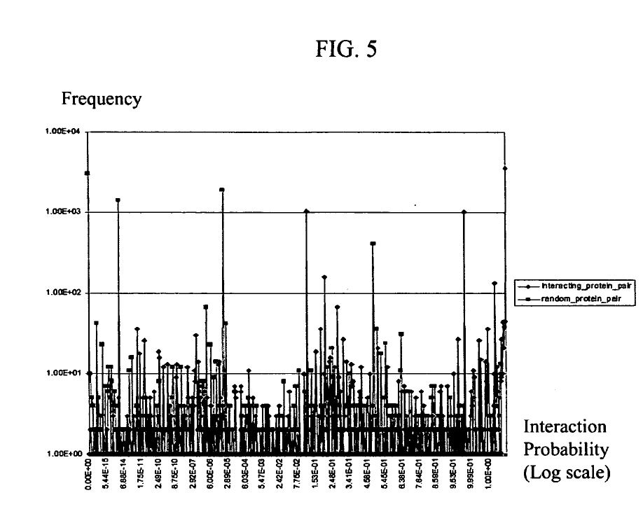

After preparing the interacting and non-interacting sets of protein pairs in the above-described manner, they were divided into learning and testing sets of protein pairs respectively. Then, using the learning sets, two AP matrices APⁱ, AP^{r} were constructed. When 80 elements of the interacting sets were used as learning sets, an n×n APⁱ matrix and an m×m AP^{r} matrix were constructed. FIG. 5 shows distributions of PIP values from interacting and non-interacting sets of protein pairs, respectively. Here, a 13,000×13,000 APⁱ matrix and a 13,000×13,000 Ap^{r} matrix were constructed.

As the matrices are huge in size and each element of the matrices represents the appearance probability, the value of each element is usually very small. In order to obtain precise results when the PIP values are computed in the next step, slight modification on the order of computation in Equation 5 is possible.

After the construction of APⁱ and AP^{r} matrices, by applying Equation 7 to all the protein pairs used in constructing the matrices, two distributions of PIP values are obtained. FIG. 5 shows distributions of PIP values from interacting and non-interacting sets of protein pairs, respectively. The PIP values of each set of protein pairs were mapped to almost all the ranges from 0 to 1 with some overlap between the two distributions. However, most PIP values from the interacting set of protein pairs are computed to be near 1 while most PIP values from non-interacting set of protein pairs are computed to be near 0. This indicates that the PIP equation could be a good classifier for discerning between interacting and non-interacting protein pairs.

For the given two distributions of PIP values, several two-category classification techniques can be applied. In order to test the validity of our prediction model, there was devised and applied a hybrid classification technique that minimizes the probability of error that is defined by Equation 9, as follows.

$$\begin{matrix}P ( e ) = {\sum }_{\{ i , j \vert {PIP}_{i}^{x} = {PIP}_{j}^{y} \}}^{} Min [ {p}_{i}^{x} , {p}_{j}^{y} ] & [ Equation 9 ] \\ {P}_{i}^{x} = \frac{{freq}_{i}^{x}}{{\sum }_{i = 1}^{m } {freq}_{i}^{x}} & \\ {P}_{i}^{y} = \frac{{freq}_{i}^{y}}{{\sum }_{i = 1}^{n } {freq}_{i}^{y}} & \end{matrix}$$

Thus, the probability of error P(e) decreases as overlapping PIP values between the two distributions decrease. Using Bayes decision rule, sensitivity and specificity of our method were measured to test the validity of the prediction model of the present invention. The reserved testing sets of interacting and non-interacting protein pairs were used for the test, and the tests were repeated 3 times changing the elements of learning set of interacting protein pairs. When 80% of the set of interacting protein pairs were used as a learning set of interacting protein pairs, approximately 86% sensitivity and approximately 56% specificity were achieved. This indicates that the prediction model of the present invention has a remarkably improved accuracy of the prediction compared to the conventional prediction model. Here, the sensitivity denotes the ratio of predicted interacting sets to actual interacting sets of the total testing sets, and the specificity denotes the ratio of predicted non-interacting sets to actual non-interacting sets of the total testing sets. This indicates that the higher the sensitivity and the specificity are, the higher the accuracy of the prediction is.

Since the interacting and non-interacting sets of protein pairs may include experimental errors, the sensitivity and the specificity calculated by the prediction model of the present invention may have errors. It is difficult to judge the precise number of erroneous data. Thus, judging from the above test result of the present invention, it is assumed that the prediction model of the present invention is effective. This result is obtained by employing dc-pairs as standard units for the interaction and by using the PIP equation for classification.

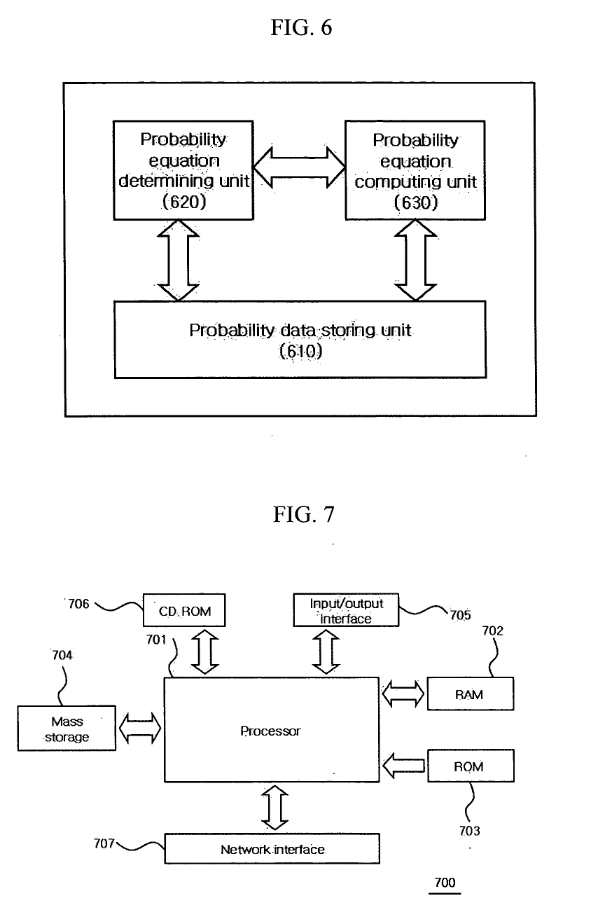

FIG. 6 is a schematic view illustrating a system 600 for predicting the interaction between proteins in accordance with the present invention. As shown in FIG. 6, the prediction system 600 comprises a probability data storing unit 610, a probability equation determining unit 620, and a probability equation computing unit 630.

The probability data storing unit 610 obtains appearance frequency information of a designated domain combination from each of interacting and non-interacting sets of protein pairs, and then stores the obtained appearance frequency information. The appearance frequency information of the domain combination is defined by the AP matrix. An element APᵢⱼ of the AP matrix is determined by Equation 3 and Equation 4, and the detailed descriptions thereof were previously stated and will thus be omitted.

The probability equation determining unit 620 serves to determine which probability equation is applied to predict the interaction between two proteins, randomly selected, using the stored appearance frequency information of domain combination. The detailed descriptions of probability equations were previously stated.

The probability equation computing unit 630 serves to compute the interaction probability between two proteins, randomly selected, using the determined probability equation. The probability equation computing unit 630 obtains probability values and distribution of the probability values by applying the determined probability equation to the interacting and non-interacting sets of protein pairs, obtains probability values by applying the determined probability equation to a given protein pair, randomly selected, and then computes a probability for determining which sets the protein pair belongs to based on the distributions of the interacting and non-interacting sets of protein pairs.

The prediction system in accordance with embodiments of the present invention includes computer readable media containing program instructions for carrying out various operations achieved by a computer. The computer readable media contains program instructions, data files, data structures or combinations thereof. The media may be designed for use for the prediction system of the present invention, or known to those skilled in the computer software field. The computer readable media includes magnetic media such as hard disks, floppy disks and magnetic tapes, optical media such as CD-ROMs and DVDs, magneto-optical media such as floptical disks, and hardware devices for storing and executing program instructions such as ROMs, RAMs and flash memories. Further, the above media includes transmission media for transmitting light including a carrier wave for transmitting a signal assigning program instructions and data structures, such as metal wires and waveguides. The program instructions include machine codes made by a compiler and high level language codes executed by a computer using an interpreter.

FIG. 7 is a block diagram of a general purpose computer employed by a method for predicting the interaction between proteins in accordance with the present invention.

The computer 700 comprises at least one processor 701 connected to a main storage including a RAM (Random Access Memory) 702 and a ROM (Read Only Memory) 703. The processor 701 is referred to as a CPU (Central Processing Unit). As well known in the art, the ROM 703 serves to unidirectionally transmit data and instructions to the processor 701, and the RAM 702 serves to bidirectionally transmit data and instructions. Each of the RAM 702 and the ROM 703 includes a suitable form of the computer readable media. A mass storage 704 is bidirectionally connected to the processor 701, thus providing an additional data storage capability. The mass storage 704 is one form selected from the above-described computer readable media. The mass storage 704 is used to store program and data, and serves as an auxiliary storage such as a hard disk having a speed lower than that of a main storage. The computer 700 may further comprise a specific mass storage such as a CD ROM 706. The processor 701 is connected to at least one input/output interface 705, such as a video monitor, a track ball, a mouse, a keyboard, a microphone, a torch screen-type display, a card reader, a magnetic or paper tape reader, a voice or letter recognizer, a joystick or other known computer input/output unit. The processor 701 is connected to a wire or wireless communication network through a network interface 707. The above described prediction method of the present invention can be achieved by such a network connection. The above-described devices and units are well known to those skilled in the computer hardware and software fields.

In order to achieve the prediction system of the present invention, the above-described hardware device is operated by at least one software module.

As apparent from the above description, the present invention provides a system and a method for predicting the interaction between proteins, which are capable of predicting the interaction between a large quantity of proteins using reduced expenses in a short time, without experimentation for testing the interaction between proteins requiring heavy expenses in a long time.

The prediction system and method of the present invention provides priority to many proteins using information predicted in a short time, and then conducts experiments according to the priority.

In accordance with the prediction system and method of the present invention, it is possible to predict the interaction probability of large-scale protein pairs in a short time. Accordingly, a network of the interaction of the large-scale protein proteins can be easily constituted based on the predicted interaction probability of protein pairs, and then core proteins among the proteins can be predicted based on the network.

In accordance with the prediction system and method of the present invention, there is provided a calculating approach to the identification of proteins, such as prediction of functions of unknown proteins.

A prediction framework of the present invention is used as a reference model, which is employed by biologists when they meet similar cases thereof.

In accordance with the prediction system and method of the present invention, since the presences of other domains affecting the interaction between proteins are considerably analyzed, it is possible to more precisely predict the interaction between proteins.

In accordance with the prediction system and method of present invention, information of random protein pairs assumed not to interact with each other is additionally used to define a probability equation, and then the probability equation is self-verified using the information by a feedback system, thus increasing accuracy of the prediction.

In accordance with the prediction system and method of the present invention, since the value of a probability that a randomly given protein pair belongs to interacting set of protein pairs is predicted, it is possible to predict the interaction between protein pairs in consideration of reality.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

1. A method for predicting the interaction between proteins, comprising the steps of:
(a) obtaining appearance frequency information of a designated domain combination selected from each of interacting and non-interacting sets of protein pairs, and storing the obtained appearance frequency information;
(b) determining a probability equation applied to predict the interaction between two proteins using the stored appearance frequency information of the domain combination; and
(c) obtaining an interaction probability value between the two proteins from the determined probability equation.

2. The prediction method as set forth in claim 1, wherein the step (a) includes the sub-steps of:
(a-1) creating a weighted appearance frequency; and
(a-2) creating an appearance probability (AP) matrix based on the weighted appearance frequency.

3. The prediction method as set forth in claim 1, wherein:
the appearance frequency information of the domain combination is defined by an appearance probability (AP) matrix; and
an element APᵢⱼ of the AP matrix is determined by below Equations,
$${AP}_{ij} = \frac{{WF}_{ij}}{{\sum }_{i , j} {WF}_{ij}}$$
$$WFab = {\sum }_{For all protein pairs pi , qj \\ s . l . < a , b > ∈ d c \cdot pair ( pi , qj )} \frac{1}{\vert ⅆ c ( {p}_{i} ) \vert \times \vert ⅆ c ( {q}_{j} ) \vert}$$

4. The prediction method as set forth in claim 1, wherein the step (c) includes the sub-steps of:
(c-1) obtaining probability values and distributions of the probability values by applying the determined probability equation to the interacting and non-interacting sets of protein pairs;
(c-2) obtaining a probability value by applying the determined probability equation to the given protein pair; and
(c-3) computing a probability for determining which set the given protein pair belongs to based on the distributions of the interacting and non-interacting sets of protein pairs.

5. A system for predicting the interaction between proteins comprising:
a probability data storing unit for obtaining appearance frequency information of a designated domain combination selected from each of interacting and non-interacting sets of protein pairs and storing the obtained appearance frequency information;
a probability equation determining unit for determining a probability equation applied to predict the interaction between two proteins, randomly selected, using the stored appearance frequency information of domain combination; and
a probability equation computing unit for computing an interaction probability between the two proteins using the determined probability equation.

6. The prediction system as set forth in claim 5,
wherein the probability equation computing unit obtains probability values and distributions of the probability values by applying the determined probability equation to the interacting and non-interacting sets of protein pairs, obtains a probability value by applying the determined probability equation to the given protein pair, and then computes a probability for determining which set the protein pair belongs to based on the distributions of the interacting and non-interacting sets of protein pairs.

7. A computer readable recording media for recording a program for achieving, by means of a computer, the prediction method as set forth in any one of claims 1 to 4.
